(19) United States
(12) Patent Application Publication
(10) Pub. No.: US 2011/0093307 A1
(43) Pub. Date: Apr. 21, 2011

(54) SYSTEM FOR PROVIDING A WORKFORCE PLANNING TOOL

(75) Inventor: Paul J. O'Keeffe, Wauwatosa, WI (US)

(73) Assignee: ACCENTURE GLOBAL SERVICES GMBH, Schaffhausen (CH)

(21) Appl. No.: 12/582,135

(22) Filed: Oct. 20, 2009

(51) Int. Cl. G06Q 10/00

(52) U.S. Cl. 705/7.14; 705/7.42

(57) ABSTRACT

A system is described for providing a workforce planning tool. The system may include a memory, an interface, and a processor. The memory may store organizational information including the number of employees, a growth percentage over a period of time, net employee turnover over the period of time, and a hiring percentage over the period of time for each hire type used by the organization. The processor may receive the information and determine a talent gap consisting of a total number of hires required based on the number of employees, the growth percentage and the net employee turnover. The processor may determine a number of hires of each hire type based on the hiring percentage for each hire type and the total number of hires, and may transform the number of hires for each hire type into a hiring strategy. The processor may provide the hiring strategy to the user.

### TECHNICAL FIELD

The present description relates generally to a system and method, generally referred to as a system, for providing a workforce planning tool, and more particularly, but not exclusively, to allowing an organization to project staffing requirements over a period of time and providing the organization with a hiring strategy for meeting the projected staffing requirements.

### BACKGROUND

Human capital may be a major source of competitive advantage for organizations. For example, studies may have shown that human capital is the most important factor for maintaining an organization's competitive advantage in the marketplace over the long term. Thus, it may be important for an organization to effectively manage its workforces to ensure their human capital is sustained over. However, a convergence of recent factors, such as expected employee exoduses due to baby boomer retirements and labor pool shrinkage due to low birth rates, may be rendering traditional systems ineffective for managing workforces within an organization.

### SUMMARY

A system for providing a workforce planning tool may include a memory, an interface, and a processor. The memory may be connected to the processor and the interface and may store an organizational profile, an organizational growth profile and an organizational hiring profile. The organizational profile may include the total number of employees in the organization. The organizational growth profile may include a growth percentage over a period of time for the organization and a net employee turnover over the period of time. The organizational hiring profile may include a hiring percentage over the period of time for each hire type used by the organization. The interface may be operative to communicate with a device of a user. The processor may receive the organizational profile, the organizational growth profile and the organizational hiring profile from the device of the user via the interface. The processor may determine a talent gap which may refer to the total number of hires required by the organization over the period of time. The talent gap may be determined based on the total number of employees, the growth percentage and the net employee turnover. The processor may determine a number of hires required over the period of time for each hire type used by the organization based on the hiring percentage for each hire type and the total number of hires. The processor may transform the number of hires required over the period of time for each hire type used by the organization into a hiring strategy. The hiring strategy may describe a strategy for fulfilling the total number of hires required over the period of time for each hire type. The hiring strategy may further include a graphical representation of the hiring strategy. The processor may provide the hiring strategy to the device of the user via the interface.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a system for providing a workforce planning tool.

FIG. 2 is a block diagram of a network environment implementing the system of FIG. 1 or other systems for providing a workforce planning tool.

FIG. 3 is a flowchart illustrating the steps of providing a hiring strategy in the system of FIG. 1 or other systems for providing a workforce planning tool.

FIG. 4 is a flowchart illustrating the steps of providing a detailed hiring strategy in the system of FIG. 1, or other systems for providing a workforce planning tool.

FIG. 5 is a flowchart illustrating the steps of providing a number of hires for multiple hire types of multiple jobs in the system of FIG. 1, or other systems for providing a workforce planning tool.

FIG. 6 is a screenshot of a user interface for inputting global values in the system of FIG. 1, or other systems for providing a workforce planning tool.

FIG. 7 is a screenshot of a user interface for inputting current year values for a functional unit in the system of FIG. 1, or other systems for providing a workforce planning tool.

FIG. 8 is a screenshot of a user interface for inputting current year business unit values in the system of FIG. 1, or other systems for providing a workforce planning tool.

FIG. 9 is a screenshot of a user interface for inputting current year functional unit values in the system of FIG. 1, or other systems for providing a workforce planning tool.

FIG. 10 is a screenshot of a user interface for inputting recruiting forecast values in the system of FIG. 1, or other systems for providing a workforce planning tool.

FIG. 11 is a screenshot of a user interface for viewing business unit historical data in the system of FIG. 1, or other systems for providing a workforce planning tool.

FIG. 12 is a screenshot of a user interface for viewing business unit current data in the system of FIG. 1, or other systems for providing a workforce planning tool.

FIG. 13 is a screenshot of a user interface for viewing business unit future data in the system of FIG. 1, or other systems for providing a workforce planning tool.

FIG. 14 is a screenshot of a user interface for viewing functional unit historical data in the system of FIG. 1, or other systems for providing a workforce planning tool.

FIG. 15 is a screenshot of a user interface for viewing functional unit current data in the system of FIG. 1, or other systems for providing a workforce planning tool.

FIG. 16 is a screenshot of a user interface for viewing functional unit future data in the system of FIG. 1, or other systems for providing a workforce planning tool.

FIG. 17 is a screenshot of a user interface for viewing functional unit recruiting forecast data in the system of FIG. 1, or other systems for providing a workforce planning tool.

FIG. 18 is a screenshot of a user interface for viewing functional unit forecast variance data in the system of FIG. 1, or other systems for providing a workforce planning tool.

FIG. 19 is a screenshot of a user interface for viewing functional unit twelve month rolling updated plan data in the system of FIG. 1, or other systems for providing a workforce planning tool.

FIG. 20 is a screenshot of a user interface for viewing forecast accuracy data in the system of FIG. 1, or other systems for providing a workforce planning tool.

FIG. 21 is a screenshot of a user interface for viewing a business unit strategy report in the system of FIG. 1, or other systems for providing a workforce planning tool.

FIG. 22 is a screenshot of a user interface for viewing a business unit recruiting plan report in the system of FIG. 1, or other systems for providing a workforce planning tool.

FIG. 23 is a screenshot of a user interface for viewing a business unit graphical report in the system of FIG. 1, or other systems for providing a workforce planning tool.

FIG. 24 is an illustration of a general computer system that may be used in the systems of FIG. 2, or other systems for providing a workforce planning tool.

### DETAILED DESCRIPTION

A system and method, generally referred to as a system, may relate to providing a workforce planning tool, and more particularly, but not exclusively, allowing an organization to project staffing requirements over a period of time and providing the organization with a hiring strategy for meeting the projected staffing requirements. The principles described herein may be embodied in many different forms.

The system may allow an organization to track and forecast their hiring needs across business units based on multiple employment metrics, such as turnover, retirements and expected growth. The system may transform the employment metrics into one or more graphical representations to allow the organization to identify potential gaps in hiring, referred to as talent gaps. The system may determine hiring strategy plans to ensure the identified gaps are fulfilled by using one more types of hires, such as full time employees, part time employees, contingent employees, contractor employees and outsourced employees. The system may further provide the organization with a rolling twelve month plan to track the organization's progress towards implementing the hiring strategies and eliminating the identified gaps. The system may provide the organization with forecast accuracy information to compare the forecasted data against the actual data. The system may provide the information to the organization at the business unit level, functional unit level, job family level, or regional level.

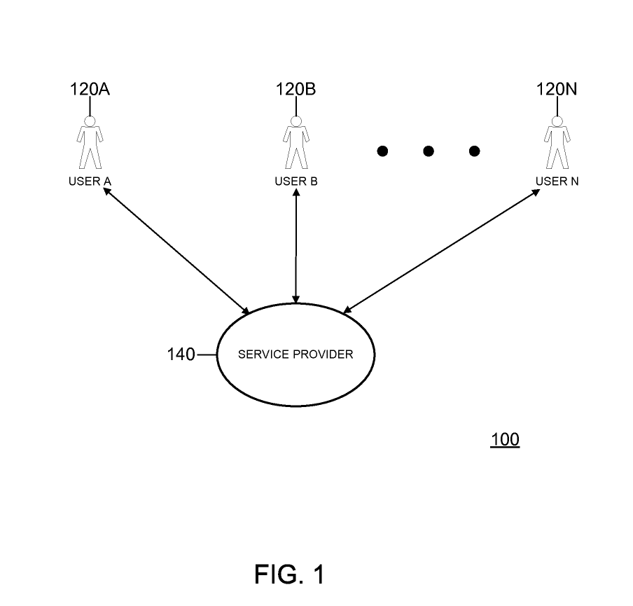

FIG. 1 provides a general overview of a system 100 for providing a workforce planning tool. Not all of the depicted components may be required, however, and some implementations may include additional components. Variations in the arrangement and type of the components may be made without departing from the spirit or scope of the claims as set forth herein. Additional, different or fewer components may be provided.

The system 100 may include one or more users 120A-N and a service provider 140. The users 120A-N may be employees of an organization who are responsible for making decisions regarding the organization's hiring and staffing needs. Alternatively, the users 120A-N may be one or more consultants who are providing consulting services to the organization, such as human resource consultants. The structure of the organization may include one or more business units or functional units. Each business unit and functional unit may include multiple families of jobs, or job families, which may be spread across multiple geographic regions. In the system 100, a job may be a particular set of responsibilities, work activities and underlying skills, and a business function may be a conceptual grouping of jobs that have similar skills, requirements and related career paths. Each job may be associated with one or more job levels which may distinguish varying levels of skill within the job.

The service provider 140 may provide the users 120A-N with a workforce planning tool, such as through a spreadsheet or a network accessible web application. The workforce planning tool may allow the users 120A-N to effectively project and manage employee staffing needs over a period of time, such as one year, three years, or five years. The service provider 140 may receive and store one or more employment metrics of the organization and may process the employment metrics to identify any potential staffing gaps within the organization. The service provider 140 may determine and provide hiring strategies to the users 120A-N to ensure the potential staffing gaps are eliminated filled.

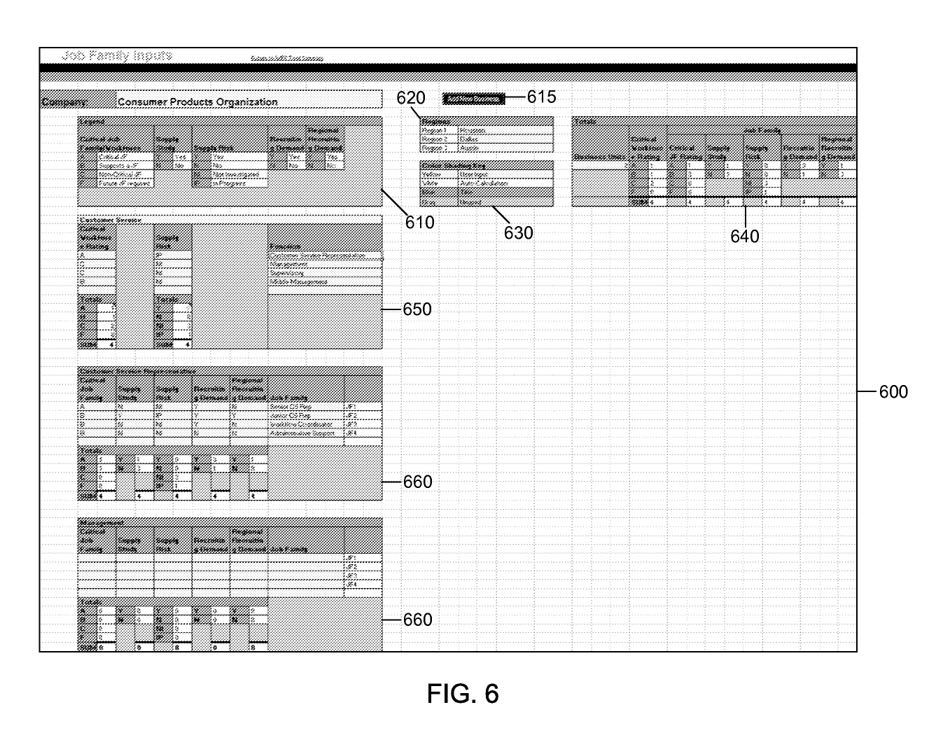

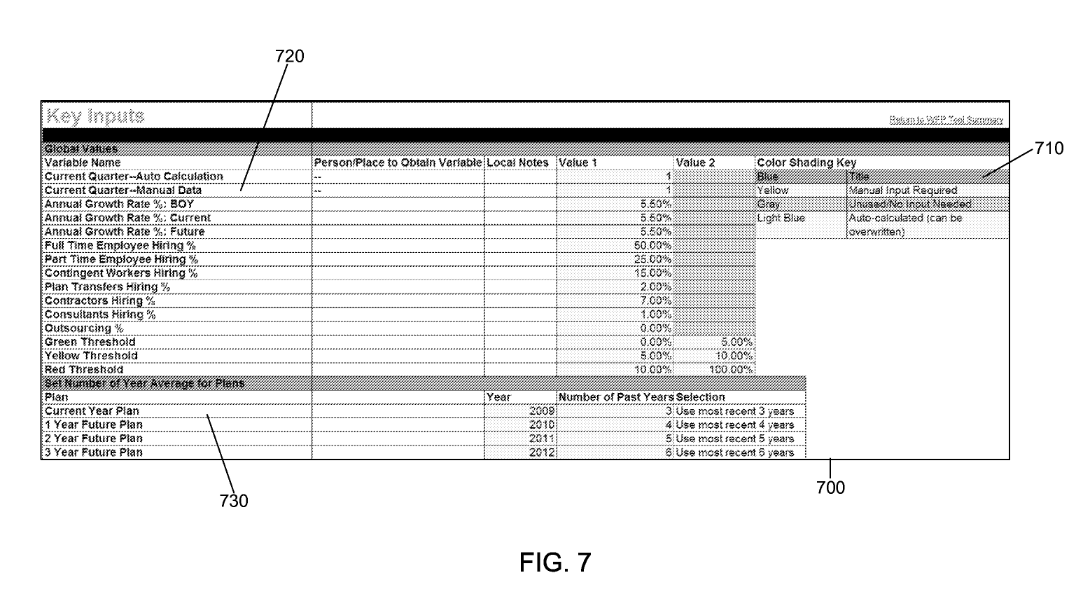

In operation, a user A 120A may provide the structure of an organization and employment metrics of the organization to the service provider 140, such as by inputting the information into a spreadsheet. For example, the user A 120A may use the user interface shown in FIG. 6 below to provide the structure of the organization. The structure of the organization may include each business unit and functional unit of the organization. The structure within each business unit and functional unit may include workforces and job families. The job families may further be segmented based on the geographic locations of the jobs within each job family. Alternatively or in addition, the user A 120A may perform an outside supply study on the job families and may flag any functional units or job families that are identified as a supply risk. The user A 120A may use the user interfaces described in FIGS. 7-10 below to provide employment metrics for each part of the organization identified above. The metrics may be based on current data, such as month-to-date, or quarter-to-date data. The employment metrics may include retirement information, turnover information, and hiring/growth information.

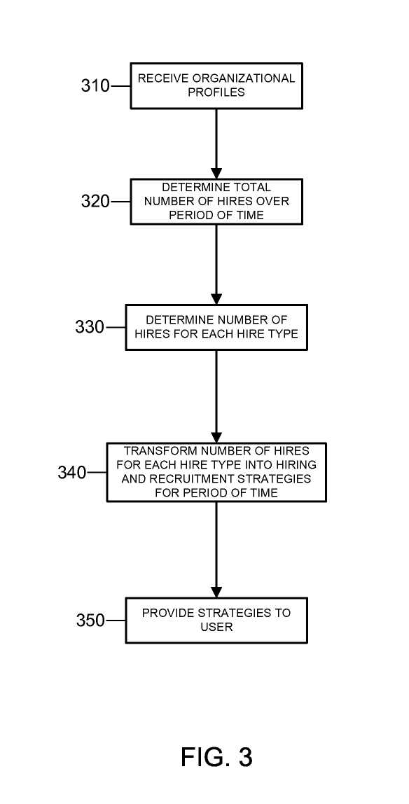

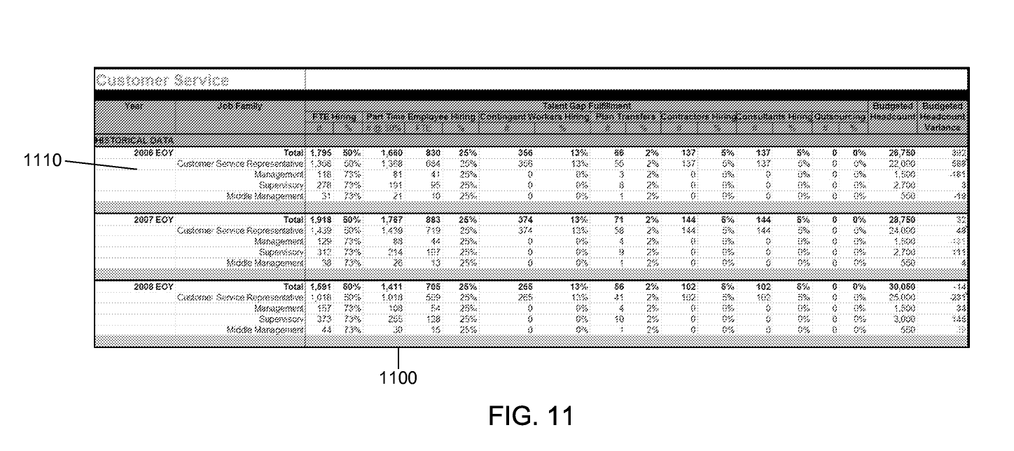

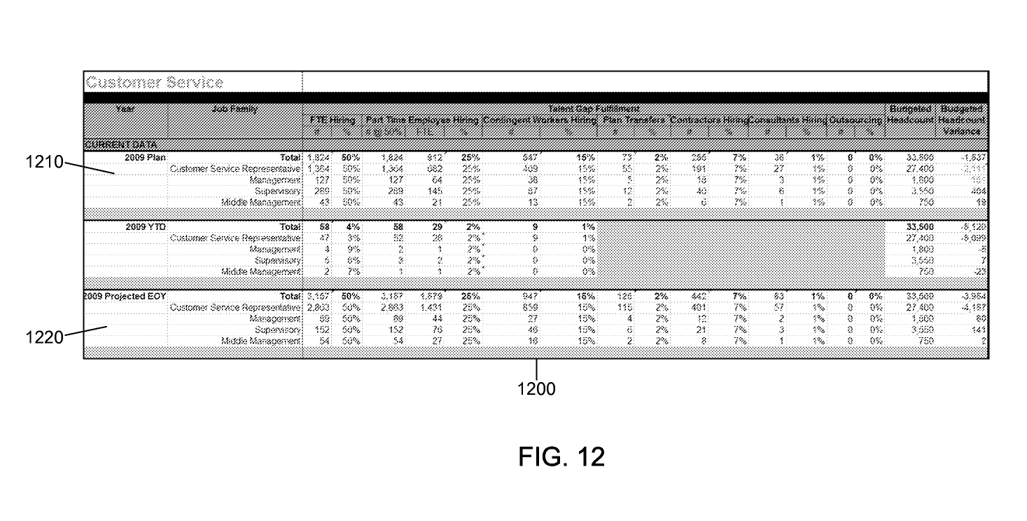

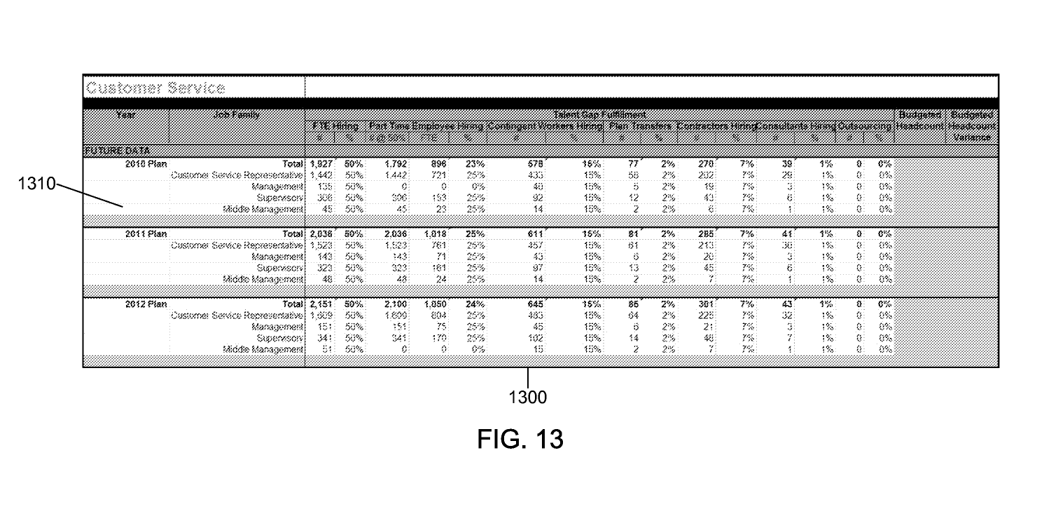

The service provider 140 may process the information provided by the user A 120A to identify any potential staffing gaps in the organization and to determine hiring strategies which may ensure the potential staffing gaps are filled. The steps of identifying potential staffing gaps and determining hiring strategies are discussed in more detail in FIGS. 3-5 below. For example, the service provider 140 may provide the user A 120A with a user interface displaying the historical business unit employment metrics of the organization, such as the user interface shown in FIG. 11 below. The service provider 140 may also provide the user A 120A with a user interface displaying the current business unit employment metrics of the organization, such as the user interface shown in FIG. 12 below. Lastly, the service provider 140 may also provide the user A 120A with a user interface displaying the future business unit employment metrics of the organization, such as the user interface shown in FIG. 13 below.

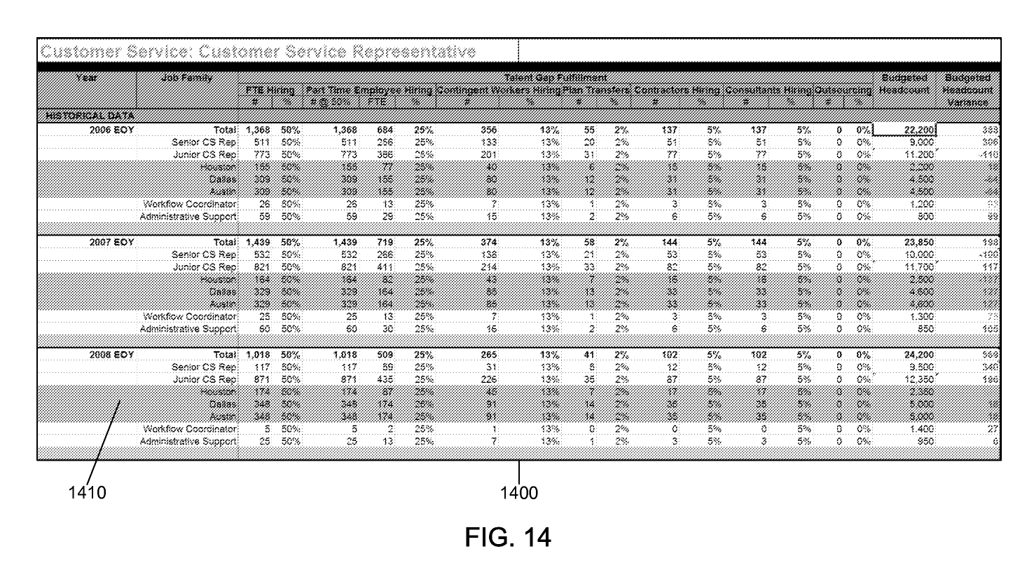

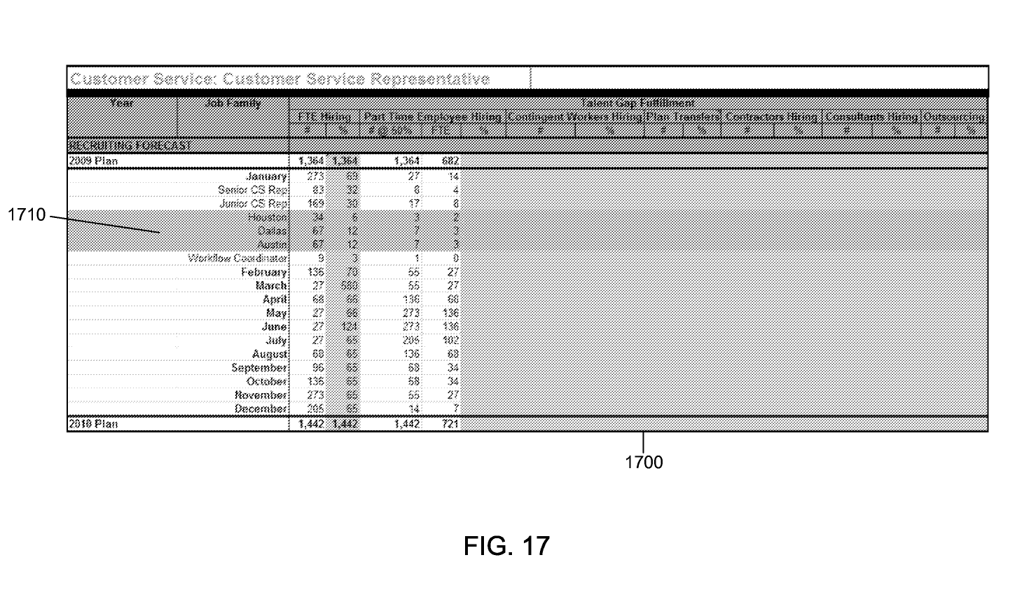

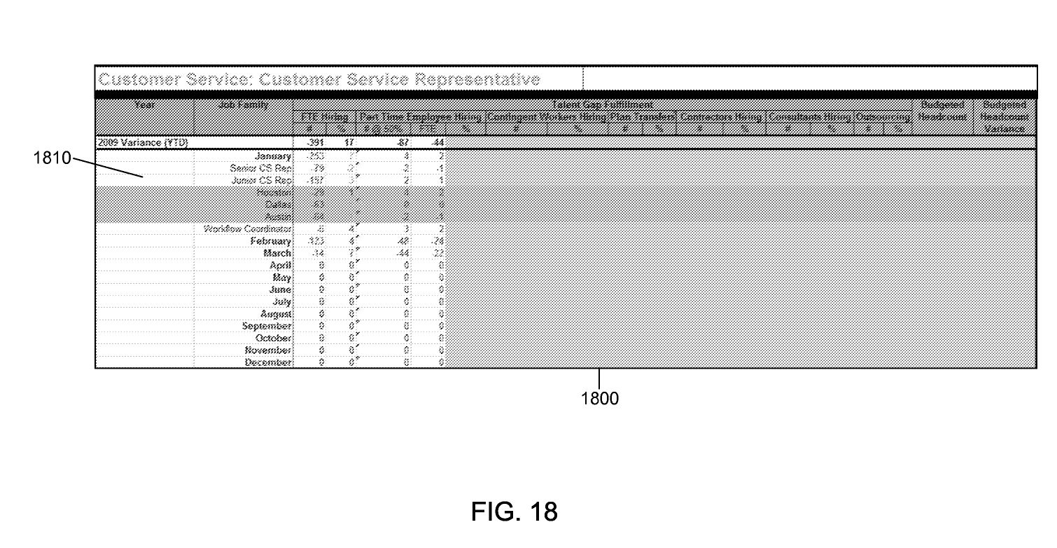

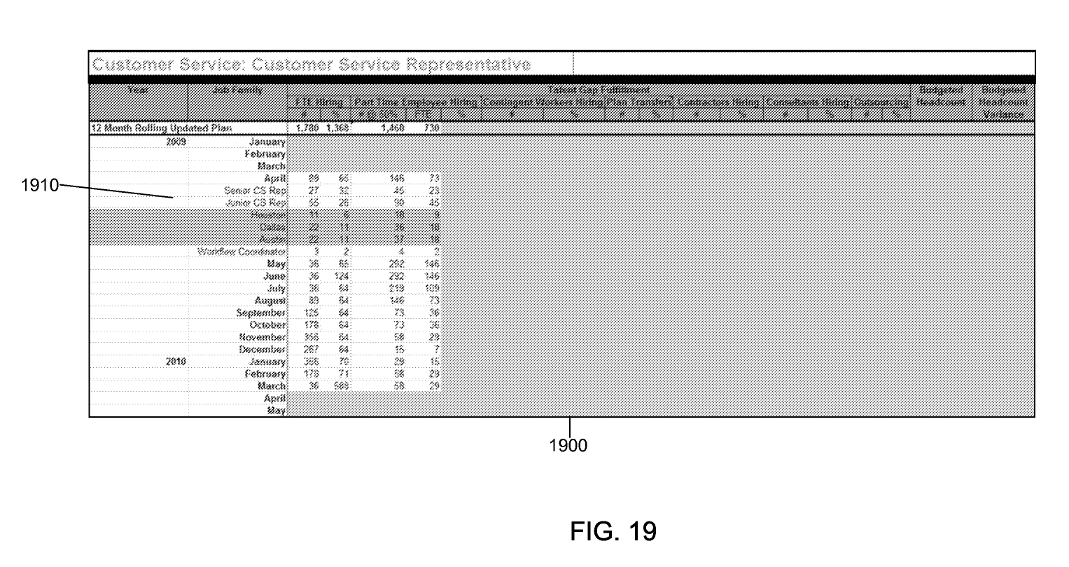

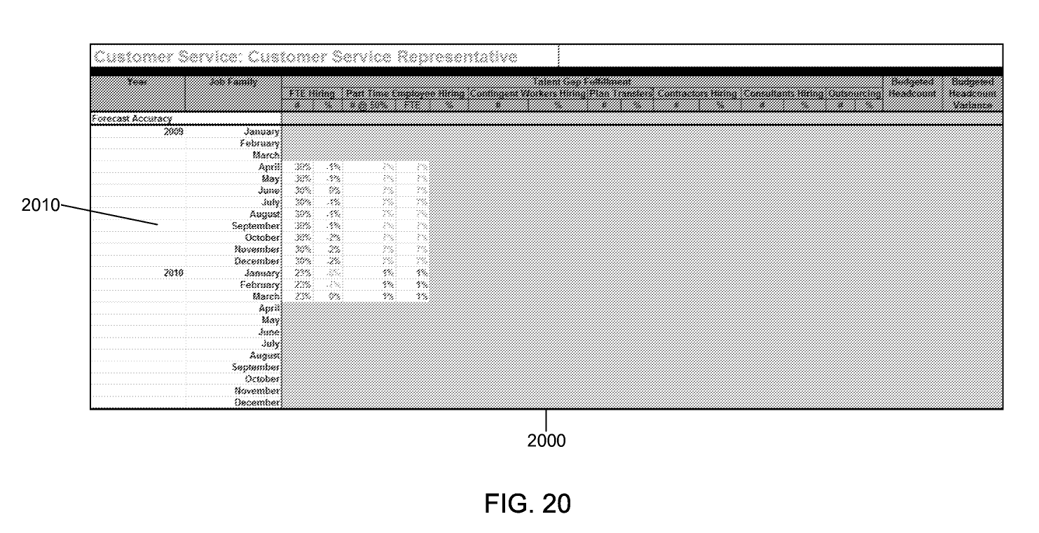

The service provider 140 may further provide the user A 120A with user interfaces displaying the employment metrics for each functional unit within the organization, such as the user interfaces shown in FIGS. 14-16 below. For each functional unit the service provider 140 may provide the user A 120A with a user interface displaying a recruiting forecast, or a hiring strategy for the functional unit, such as the user interface displayed in FIG. 17 below. The service provider 140 may provide the user A 120A with a user interface displaying the variance between the hiring strategy and the actual hiring of the organization, such as the user interface shown in FIG. 18 below. The service provider 140 may also provide the user A 120A with a user interface displaying a twelve month rolling plan, or hiring strategy, such as the user interface displayed in FIG. 19 below. Lastly, the service provider 140 may provide the user A 120A with a user interface displaying the accuracy of the recruiting forecast of the user A 120A, such as the user interface displayed in FIG. 20 below.

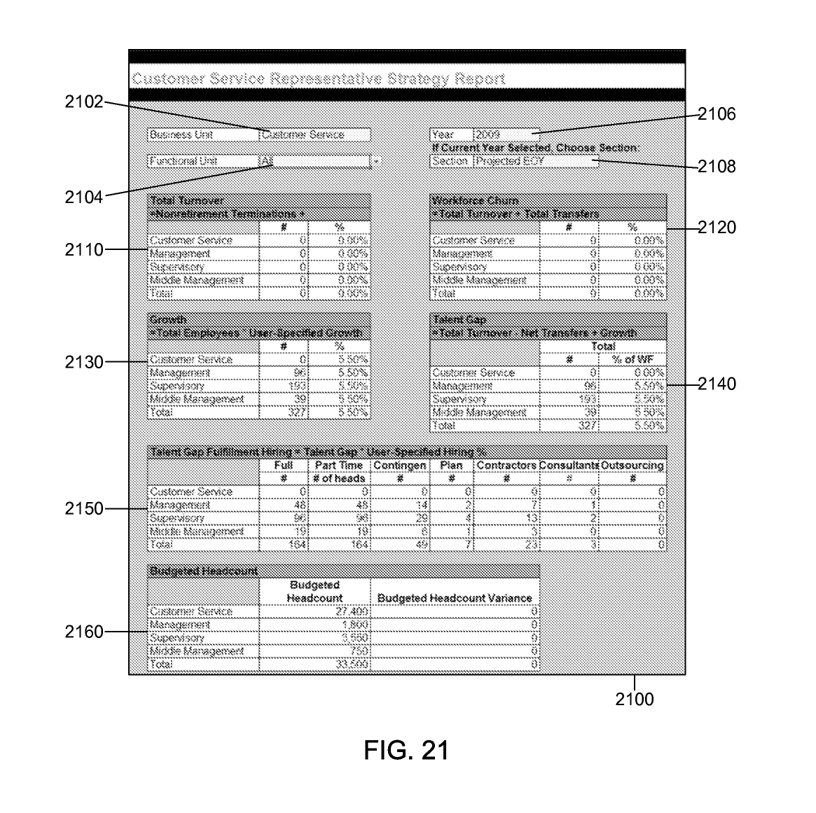

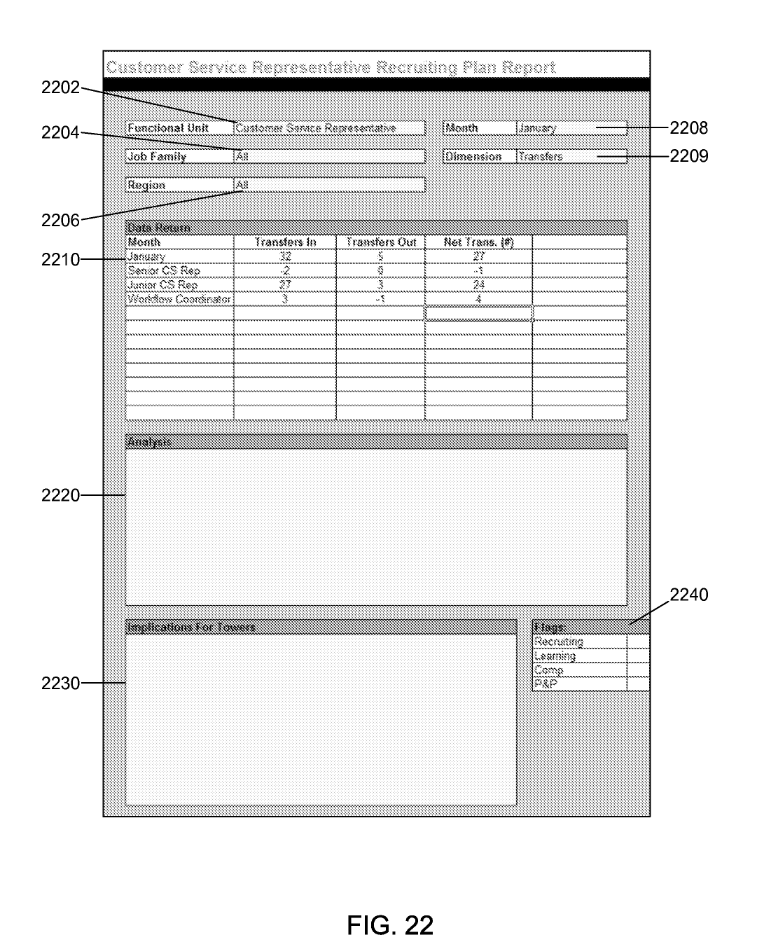

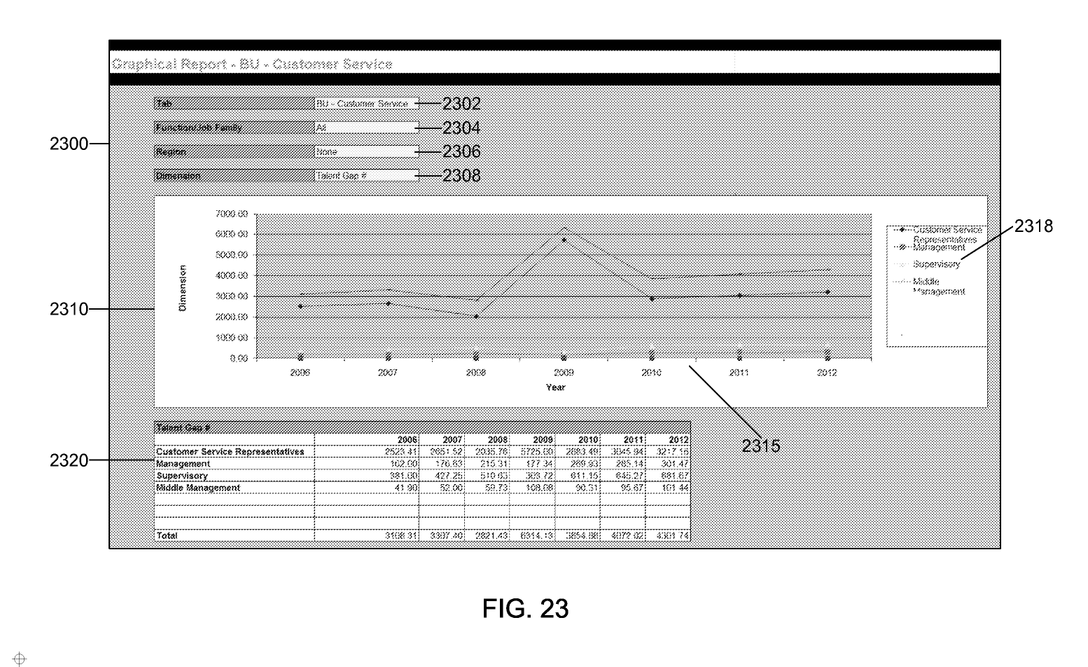

In addition, the service provider 140 may provide the user A 120A with one or more interactive user interfaces for viewing the hiring strategy, such as the interactive user interface described in FIG. 21 below. The interactive user interface may allow the user A 120A to view the hiring strategy based on a business unit, a functional unit, and a year. The service provider 140 may also provide the user A 120A with an interactive user interface displaying the recruiting plan of the organization, such as the user interface shown in FIG. 22 below. The interactive user interface may allow the user A 120A to view a recruiting plan based on a functional unit, a job family, a region, a month, and/or a particular metric. Lastly, the service provider 140 may provide the user A 120A with an interactive user interface for viewing employment metrics in a graphical form for each business unit or functional unit, such as the user interface shown in FIG. 23 below. The interactive user interface may allow the user A 120A to view employment metrics based on a business unit or functional unit, a function or job family, a geographical region, or a metric.

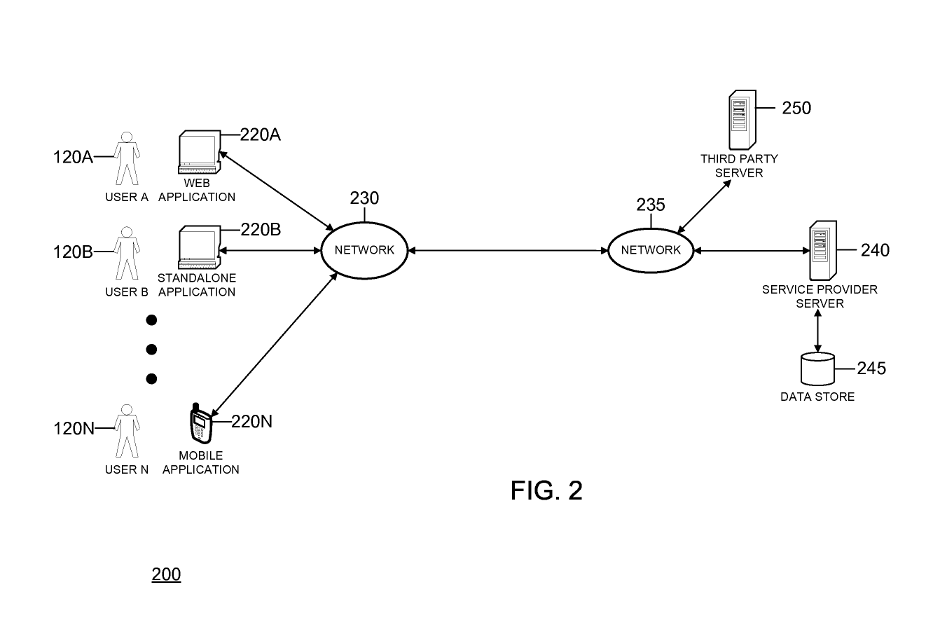

FIG. 2 provides a simplified view of a network environment 200 implementing the system of FIG. 1 or other systems for providing a workforce planning tool. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The network environment 200 may include one or more users 120A-N, a service provider server 240, a third party server 250, a data store 245, networks 230, 235, and one or more web applications, standalone applications, mobile applications 220A-N, which may collectively be referred to as client applications. Some or all of the service provider server 240 and the third party server 250 may be in communication with each other by way of network 235.

The networks 230, 235 may include wide area networks (WAN), such as the Internet, local area networks (LAN), campus area networks, metropolitan area networks, or any other networks that may allow for data communication. The network 230 may include the Internet and may include all or part of network 235; network 235 may include all or part of network 230. The networks 230, 235 may be divided into sub-networks. The sub-networks may allow access to all of the other components connected to the networks 230, 235 in the system 200, or the sub-networks may restrict access between the components connected to the networks 230, 235. The network 235 may be regarded as a public or private network connection and may include, for example, a virtual private network or an encryption or other security mechanism employed over the public Internet, or the like.

The web applications, standalone applications and mobile applications 220A-N may be connected to the network 230 in any configuration that supports data transfer. This may include a data connection to the network 230 that may be wired or wireless. Any of the web applications, standalone applications and mobile applications 220A-N may individually be referred to as a client application. The web application 220A may run on any platform that supports web content, such as a web browser or a computer, a mobile phone, personal digital assistant (PDA), pager, network-enabled television, digital video recorder, such as TIVO®, automobile and/or any appliance or platform capable of data communications. The web application 220A may support a rich internet application implemented with the ADOBE FLEX® technologies. Alternatively or in addition the web application 220A may be developed using one or more of the following technologies: ADOBE FLEXBUILDER 3®, ADOBE FLEX SUBCLIPSE®, or generally any web development technologies.

The standalone application 220B may run on a machine that may have a processor, memory, a display, a user interface and a communication interface. The processor may be operatively connected to the memory, display and the interfaces and may perform tasks at the request of the standalone application 220B or the underlying operating system. The memory may be capable of storing data. The display may be operatively connected to the memory and the processor and may be capable of displaying information to the user B 120B. The user interface may be operatively connected to the memory, the processor, and the display and may be capable of interacting with a user B 120B. The communication interface may be operatively connected to the memory, and the processor, and may be capable of communicating through the networks 230, 235 with the service provider server 240. The standalone application 220B may be programmed in any programming language that supports communication protocols. These languages may include: SUN JAVA®, C++, C#, ASP, SUN JAVASCRIPT®, asynchronous SUN JAVASCRIPT®, or ADOBE FLASH ACTIONSCRIPT®, ADOBE FLEX®, amongst others.

The mobile application 220N may run on any mobile device that may have a data connection. The data connection may be a cellular connection, a wireless data connection, an internet connection, an infra-red connection, a Bluetooth connection, or any other connection capable of transmitting data. For example, the mobile application 220N may be an application running on an APPLE IPHONE®.

The service provider server 240 may include one or more of the following: an application server, a mobile application server, a data store, a database server, and a middleware server. The service provider server 240 may exist on one machine or may be running in a distributed configuration on one or more machines.

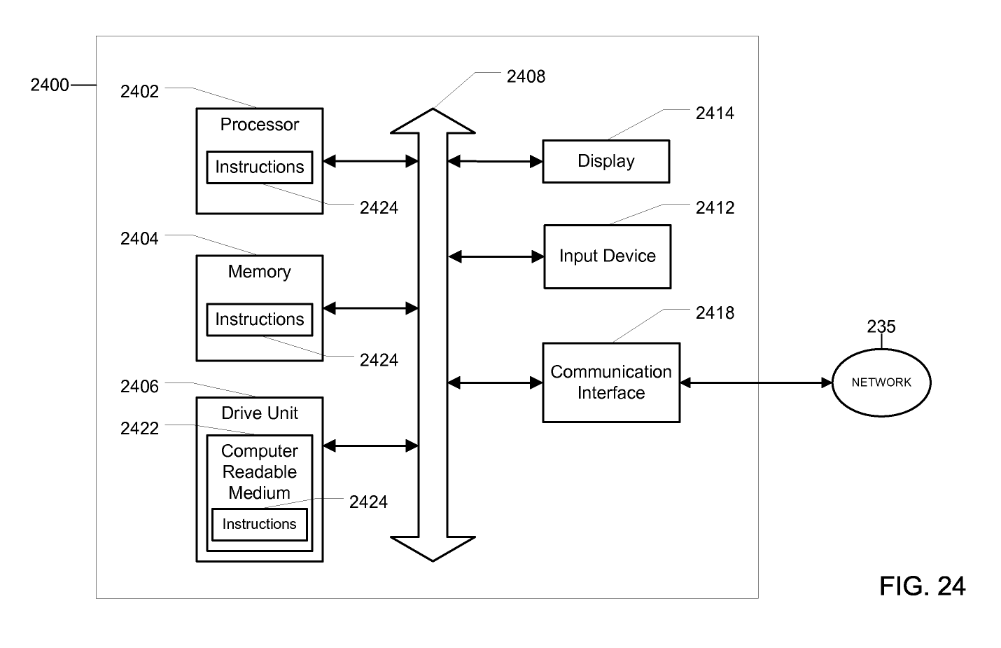

The service provider server 240 and client applications 220A-N may be one or more computing devices of various kinds, such as the computing device in FIG. 24. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, the web application 220A may employ the Hypertext Transfer Protocol (“HTTP”) to request information, such as a web page, from a web server, which may be a process executing on the service provider server 240.

There may be several configurations of database servers, application servers, mobile application servers, and middleware applications included in the service provider server 240. The data store 245 may be part of the service provider server 240 and may be a database server, such as MICROSOFT SQL SERVER®, ORACLE®, IBM DB2®, SQLITE®, or any other database software, relational or otherwise. The application server may be APACHE TOMCAT®, MICROSOFT IIS®, ADOBE COLDFUSION®, or any other application server that supports communication protocols.

The networks 230, 235 may be configured to couple one computing device to another computing device to enable communication of data between the devices. The networks 230, 235 may generally be enabled to employ any form of machine-readable media for communicating information from one device to another. Each of networks 230, 235 may include one or more of a wireless network, a wired network, a local area network (LAN), a wide area network (WAN), a direct connection such as through a Universal Serial Bus (USB) port, and the like, and may include the set of interconnected networks that make up the Internet. The networks 230, 235 may include any communication method by which information may travel between computing devices.

In operation, the user A 120A may access the service provided by the service provider server 240 through the web application 220A and the network 230. The user A 120A may interact with the service provider server 240 through the web application 220A. The data may be passed between the web application 220A and the database 245. The majority of the calculations may be performed on the service provider server 240, although some calculations may be completed on the web application 220A in order to speed up response times.

Alternatively or in addition, the users 120A-N may access the system 100 through a spreadsheet, such as a MICROSOFT EXCEL® spreadsheet. In this case, an application for accessing the spreadsheet, such as MICROSOFT EXCEL®, may be running on the service provider server 240. The users 120A-N may access the application directly through an interface connected to the service provider server 240, such as a keyboard and/or a pointing device.

FIG. 3 is a flowchart illustrating the steps of providing a hiring strategy in the system of FIG. 1 or other systems for providing a workforce planning tool. The steps of FIG. 3 are described as being performed by the service provider server 240. However, the steps may be performed by the processor of the service provider server 240, or by any other hardware component of the service provider server 240. Alternatively the steps may be performed by an external hardware component or software process.

At step 310, the service provider server 240 may receive organizational profiles of an organization, such as from a device of the user A 120A. The service provider server 240 may provide the user A 120A with one or more user interfaces for inputting the structure of the organization and employment metrics of the organization, such as the user interfaces described in FIGS. 6-10. For example, the user A 120A may provide an organizational profile, an organizational hiring profile and an organizational growth profile. The organizational profile may describe the structure of the organization, such as the various levels of the organization, and the number of employees at each level of the organization. The organizational growth profile may describe the amount of the growth the organization expects to achieve over a period of time and the amount of employee turnover the organization expects to incur over the period of time. The amount of employee turnover may be based on a number of expected retirements, a number of expected non-retirement terminations, or a number of employee transfers. The organizational hiring profile may describe the hire types used by the organization, such as full time employees, part time employees, contingent employees, contractor employees or outsourcing employees, and a percentage of the overall hiring targeted to each hire type. For example, the organization may target fifty percent of hires to be full time employees, twenty-five percent of hires to be part-time employees and twenty-five percent of hires to be contingent employees.

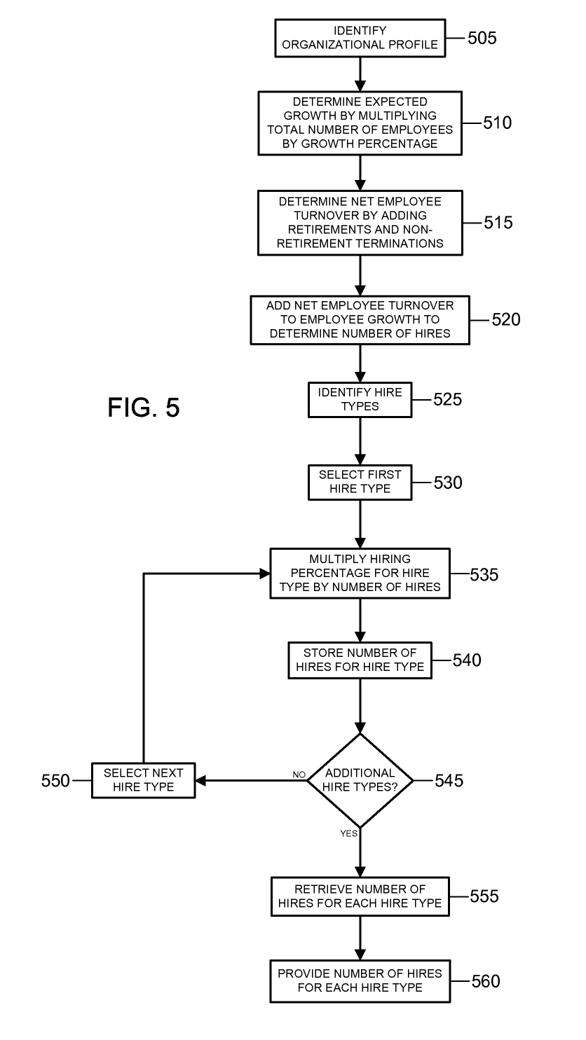

At step 320, the service provider server 240 may process the received profiles and may determine the total number of hires required over a period of time. The period of time may be one year, one month, or generally any period of time. The total number of hires required may be based on the number of employees, the expected growth and the expected employee turnover over the period of time. The steps of determining the total number of hires are discussed in more detail in FIG. 5 below. At step 330, the service provider server 240 determines the number of hires for each hire type over the period of time. The number of hires for each hire type may be based on the total number of hires and the percentage of hiring targeted to each hire type.

At step 340, the service provider server 240 may transform the number of hires for each hire type into a hiring strategy and a recruitment strategy over the period of time. The strategies may provide guidance for several time intervals over the period of time. For example, if the period of time is one year, the strategies may provide guidance at monthly intervals over the course of the year. At step 350, the service provider server 240 may provide the hiring and recruitment strategies to the user A 120A. For example, the service provider server 240 may provide the user A 120A with the user interfaces shown in FIGS. 21-22 below. Alternatively or in addition, the service provider 240 may provide the user A 120A with the user interfaces described in FIGS. 6-23 below.

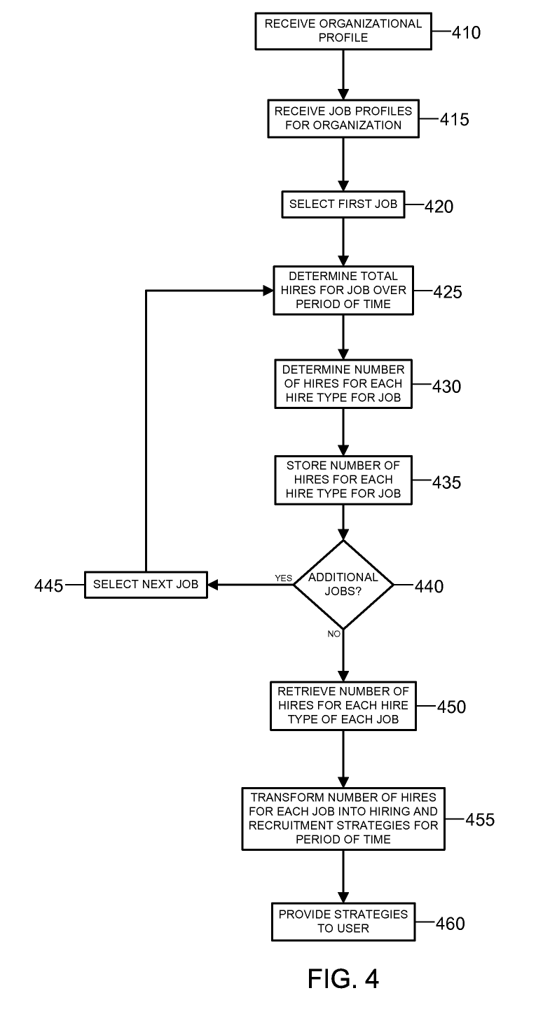

FIG. 4 is a flowchart illustrating the steps of providing a detailed hiring strategy in the system of FIG. 1, or other systems for providing a workforce planning tool. The steps of FIG. 4 are described as being performed by the service provider server 240. However, the steps may be performed by the processor of the service provider server 240, or by any other hardware component of the service provider server 240. Alternatively the steps may be performed by an external hardware component or software process.

At step 410, the service provider server 240 may receive an organizational profile, such as through a spreadsheet application or from a device of the user A 120A. For example, the user A 120A may use the user interface shown in FIG. 6 below to provide a profile of the organization. At step 415, the service provider server 240 may receive one or more job profiles of the organization. The job profiles may include employment metrics of individual jobs within the organization. Alternatively or in addition, the job profiles may include employment metrics of individual business units or individual functional units within the organization.

At step 420, the service provider server 240 may select the first job from the job profiles provided by the user A 120A. At step 425, the service provider server 240 may determine the total number of hires required by the organization over a period of time for the job. The total number of hires may be based on the expected growth for the job over the period of time and the expected net turnover for the job over the period of time. The steps of determining the total number of jobs is discussed in more detail in FIG. 5 below.

At step 430, the service provider server 240 determines the number of hires for each hire type for the job. The hire types for the job may be identified by the user A 120A in the job profile and may include full time employees, part time employees, contingent employees, contractor employees, or outsourced employees. The number of hires for each hire type for the job may be based on the target percentage of each hire type for the job. The steps of determining the number of hires for each hire type of a job may be discussed in more detail in FIG. 5 below.

At step 435, the service provider server 240 may store the number of hires for each hire type for the job, such as in the data store 245. At step 440, the service provider server 240 may determine whether there are any additional jobs identified in the job profiles provided by the user A 120A. If, at step 440, the service provider server 240 determines that there are additional job identified in the job profiles, the service provider server 240 moves to step 445. At step 445, the service provider server 240 selects the next job identified in the job profiles provided by the user A 120A and repeats steps 425-440 for the next job.

If, at step 440, the service provider server 240 determines that there are no additional jobs identified in the job profiles provided by the user A 120A, the service provider server 240 moves to step 450. At step 450, the service provider server 240 retrieves the stored number of hire types for each of the jobs identified by the user A 120A, such as from the data store 245. At step 455, the service provider server 240 transforms the number of hire types for each of the jobs into a hiring strategy and a recruiting strategy for the period of time. Alternatively or in addition, the strategies may provide guidance for smaller time intervals of the period of time. For example, if the period of time is one year, the strategies may provide guidance at monthly intervals over the course of the year. At step 460, the service provider server 240 may provide the hiring and recruitment strategies to the user A 120A. For example, the service provider server 240 may provide the user A 120A with the user interfaces shown in FIGS. 21 and 22 below. Alternatively or in addition, the service provider 240 may provide the user A 120A with the user interfaces described in FIGS. 6-23 below.

FIG. 5 is a flowchart illustrating the steps of providing a number of hires for multiple hire types of multiple jobs in the system of FIG. 1, or other systems for providing a workforce planning tool. The steps of FIG. 5 are described as being performed by the service provider server 240. However, the steps may be performed by the processor of the service provider server 240, or by any other hardware component of the service provider server 240. Alternatively the steps may be performed by an external hardware component or software process.

At step 505, the service provider server 240 may identify an organizational profile for which to determine a number of hires for multiple hire types of a job, business unit or functional unit over a period of time. The organizational profile may include a current number of employees, a growth percentage over the period of time, a number of expected retirements, a number of expected non-retirement terminations, the hire types, and a target percentage of hiring for each hire type. At step 510, the service provider server 240 may determine the expected growth over the period of time by multiplying the total number of employees by the growth percentage. At step 515, the service provider server 240 may determine the net employee turnover by adding the number of expected retirements to the number of expected non-retirement terminations. Alternatively or in addition, the service provider server 240 may add a net number of employee transfers for the job, business unit, or functional unit to the net employee turnover. The net number of employee transfers may be the number of employee transfers into the job, business unit, or functional unit subtracted from the number of employee transfers out of the job, business unit, or functional unit.

At step 520, the service provider server 240 may add the net employee turnover to the employee growth to determine the number of hires required over the period of time. At step 525, the service provider server 240 may identify the hire types provided by the user A 120A. At step 530, the service provider server 240 may select the first hire type and may identify the target hiring percentage for the hire type. At step 535, the service provider server may multiply the target hiring percentage for the hire type by the total number of hires. At step 540, the service provider server 240 may store the number of hires for the hire type, such as in the data store 245. At step 545, the service provider server 245 may determine whether there are additional hire types provided by the user A 120A. If, at step 545, the service provider server 240 determines there are additional hire types, the service provider server 240 moves to step 550. At step 550, the service provider server 240 selects the next hire type and determines the target hiring percentage for the hiring type. The service provider server 240 then repeats steps 535-545 for the next hire type.

If, at step 545, the service provider server 240 determines that there are no additional hire types identified by the user A 120A, the service provider server 240 moves to step 555. At step 555, the service provider server 240 retrieves the number of hires for each hire type, such as from the data store 245. At step 560, the service provider server 240 provides the number of hires for each hire type, such as to a device of the user A 120, or to another component of the system 100. For example, the service provider server 240 may provide the user A 120A with the user interfaces shown in FIGS. 21-22 below.

FIG. 6 is a screenshot of a user interface 600 for inputting global values in the system of FIG. 1, or other systems for providing a workforce planning tool. The user interface 600 may include a legend 610, an add new business unit button 615, a regions table 620, a color shading key 630, a totals table 640, a business unit table 650 and one or more functional unit tables 660.

In operation, the user A 120 may provide the structure of the organization through the user interface 600. The user A 120A may add one or more business units by clicking on the add business new business unit button 615. For each business unit, the user A 120A may provide one or more functional units. For each functional unit the service provider 240 may create a functional unit table 660. The user A 120A may provide information regarding each functional unit in each functional unit table 660, such as supply study values, supply risk values, recruiting demand values, regional recruiting demand values, and job families. The color shading key 630 may indicate which fields in the tables 650, 660 are titles, which fields require user input, which fields are auto-calculated by the service provider server 240 and which fields are not used.

FIG. 7 is a screenshot of a user interface 700 for inputting current year values for a functional unit in the system of FIG. 1, or other systems for providing a workforce planning tool. The user interface 700 may include a color shading key 710, a global values table 720, and a number of years table 730.

In operation, the user A 120A may provide the global values for the organization in the global values table 720. The global values table may include growth rates, hiring percentages for each hire type and threshold values. The user A 120A may provide the average number of years for the hiring and recruiting strategies in the number of years table 730. The color shading key 710 may indicate which fields in the tables 720, 730 are titles, which fields require manual input, which fields are not used and which fields are auto-calculated by the service provider server 240. Alternatively or in addition, the fields which are auto-calculated by the service provider server 240 may be overwritten by the user A 120A.

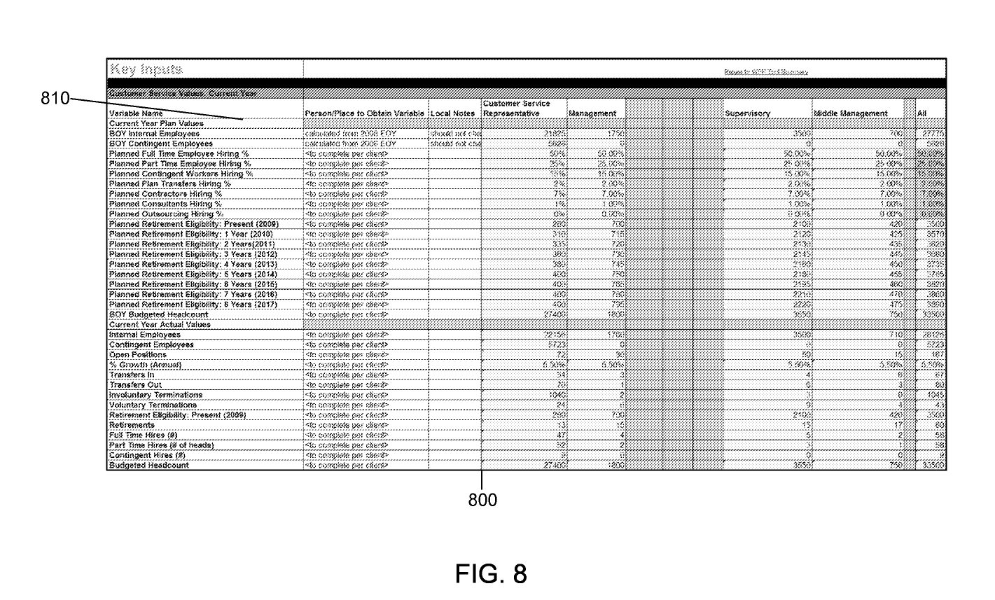

FIG. 8 is a screenshot of a user interface 800 for inputting current year values for a business unit values in the system of FIG. 1, or other systems for providing a workforce planning tool. The user interface 800 may include a business unit inputs table 810. The user A 120A may use the business unit inputs table 810 to provide hiring values related to a business unit. The user A 120A may provide values for each business unit in the organization in separate business unit inputs tables 810. For example, the user A 120A may provide the number of employees in the business unit, the hire types used in the business unit, the target percentage of hiring for each hire type, the budgeted values for the business unit, or any of the other values identified in the business unit inputs table 810.

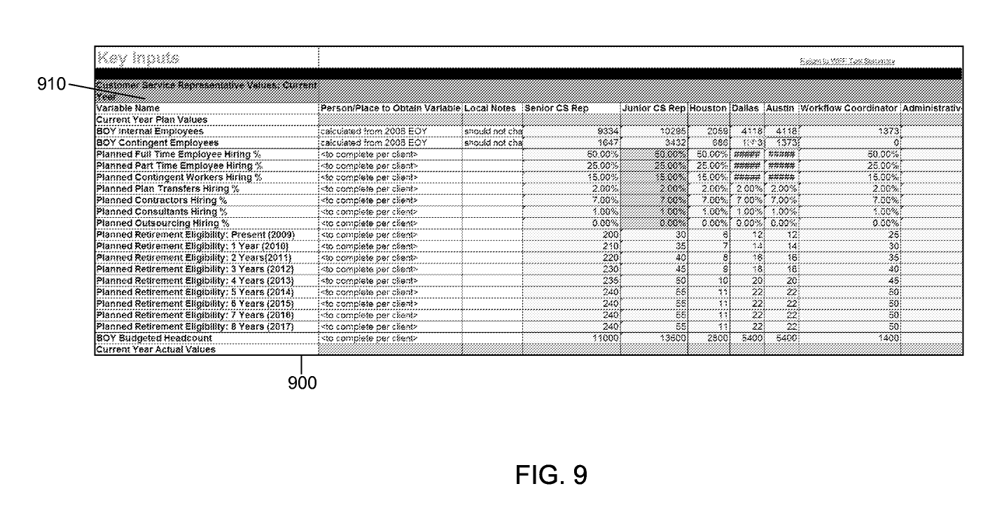

FIG. 9 is a screenshot of a user interface 900 for inputting current year values for a functional unit in the system of FIG. 1, or other systems for providing a workforce planning tool. The user interface 900 may include a functional unit inputs table 910. In operation, the user A 120A may provide values related to a functional unit in the functional unit inputs table 910. The user A 120A may provide values for each functional unit of each business unit of the organization in separate function unit inputs table 910. For example, the user A 120A may provide the number of employees in the functional unit, the hire types used in the functional unit, the target percentage of hiring for each hire type, the budgeted values for the functional unit, or any of the other values identified in the functional unit inputs table 910.

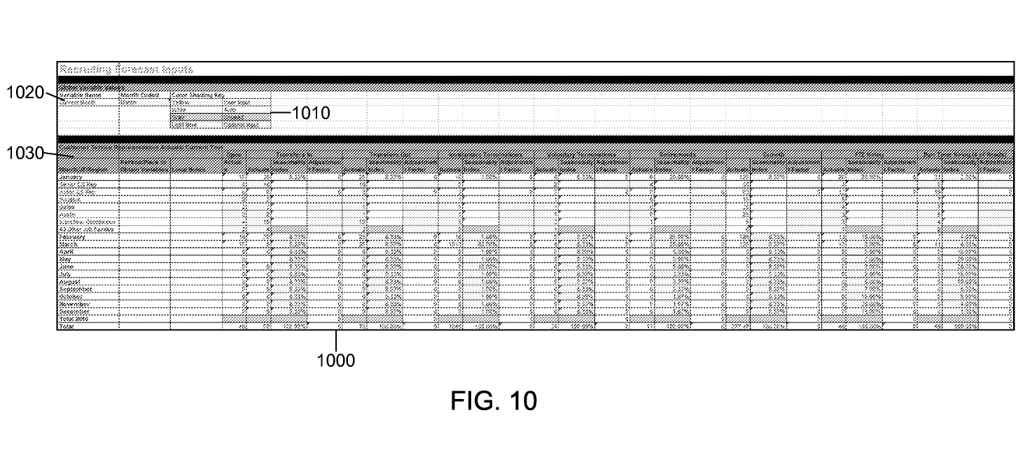

FIG. 10 is a screenshot of a user interface 1000 for inputting recruiting forecast values in the system of FIG. 1, or other systems for providing a workforce planning tool. The user interface 1000 may include a color shading key 1010, a global variable values table 1020, and a recruiting inputs table 1030. In operation, the user A 120A may input the recruiting forecast metrics into the recruiting inputs table 1030. The user A 120A may use the color shading key 1010 to determine which fields in the tables 1020, 1030 require user input, which fields are auto-calculated by the service provider server 240, which fields are not used and which fields are for optional input. Alternatively or in addition, the fields which are auto-calculated by the service provider server 240 may be overwritten by the user A 120A.

The user A 120A may recruiting forecast values into the user interface 1000 on a period basis, such as monthly, quarterly, annually, or generally any period of time. The recruiting forecast values may include values related to the expected attrition of employees, such as through terminations, retirements, or transfers out. Alternatively or in addition, the recruiting forecast values may also include values related to expected growth of employees.

FIG. 11 is a screenshot of a user interface 1100 for viewing business unit historical data in the system of FIG. 1, or other systems for providing a workforce planning tool. The user interface 1100 may include a historical data table 1110. In operation, the user A 120A may view the historical hiring data for each job family of a business unit in the historical data table 1110. The data provided in the historical data table may be based on information provided by the user A 120A in FIGS. 6-10. The data may be displayed for multiple periods of time, such as previous years or months.

In the historical data table 1110, the user A 120A may view the historical hiring data for each hire type of each job family over the periods of time. For example, the user A 120A may view the full time hiring, part time hiring contingent hiring, contractor hiring, consultant hiring and outsourcing hiring for each job family over the previous three years. The user A 120A may also view the headcount budgeted for each job family and the variance between the actual hiring values and the budgeted headcount. The values in the user interface 1100 may assist the user A 120A with forecasting future hiring values.

FIG. 12 is a screenshot of a user interface 1200 for viewing business unit current data in the system of FIG. 1, or other systems for providing a workforce planning tool. The user interface 1200 may include a current data table 1210 and a projected end-of-year table 1220. In operation, the user A 120A may view the planned data for each job family and the year to date data for each job family of a business unit in the current data table 1210. The user A 120A may view the projected end of year data for each job family of the business unit in the projected end-of-year table 1220. The data provided in the current data table 1210 and projected end-of-year table 1220 may be based on information provided by the user A 120A in FIGS. 6-10.

In the current data table 1210, the user A 120A may view the planned and current hiring data for each hire type of each job family. For example, the user A 120A may view the planned full time hiring, part time hiring contingent hiring, contractor hiring, consultant hiring and outsourcing hiring for each job family. The user A 120A may also view the year to date hiring for each job family in the current data table 1210. The user A 120A may also view the headcount budgeted for each job family for the year and the current variance between the actual hiring values and the budgeted headcount. In the projected end-of-year table 1220, the user A 120A may view the hiring values projected through the end of the year.

FIG. 13 is a screenshot of a user interface 1300 for viewing business unit future data in the system of FIG. 1, or other systems for providing a workforce planning tool. The user interface 1300 may include a future data table 1310. In operation, the user A 120A may view the future data for each job family of a business unit in the future data table 1310. For example, the service provider server 240 may process the data provided by the user A 120A in the user interfaces of FIGS. 6-10 to determine the future data for each job family of the business unit displayed in the future data table 1310.

In the future data table 1310, the user A 120A may view the future hiring data for each hire type of each job family over multiple periods of time. For example, the user A 120A may view the full time hiring, part time hiring contingent hiring, contractor hiring, consultant hiring and outsourcing hiring for each job family over the next three years.

FIG. 14 is a screenshot of a user interface 1400 for viewing functional unit historical data in the system of FIG. 1, or other systems for providing a workforce planning tool. The user interface 1400 may include a historical data table 1410. In operation, the user A 120A may view the historical data for each job in a functional unit in the historical data table 1410. The data provided in the historical data table 1410 may be based on information provided by the user A 120A in FIGS. 6-10.

In the historical data table 1410, the user A 120A may view the historical hiring data for each hire type of each job in the functional unit over the periods of time. For example, the user A 120A may view the full time hiring, part time hiring contingent hiring, contractor hiring, consultant hiring and outsourcing hiring for each job over the previous three years. The user A 120A may also view the headcount budgeted for each job and the variance between the actual hiring values and the budgeted headcount. The values in the user interface 1100 may assist the user A 120A with forecasting future hiring values.

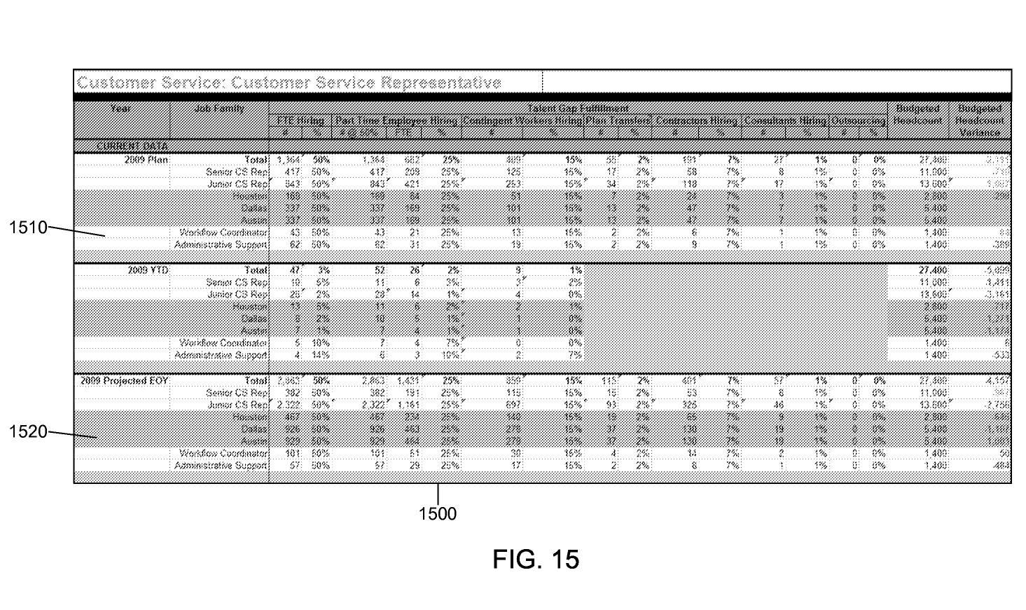

FIG. 15 is a screenshot of a user interface 1500 for viewing functional unit current data in the system of FIG. 1, or other systems for providing a workforce planning tool. The user interface 1500 may include a current data table 1510 and a projected end-of-year table 1520. In operation, the user A 120A may view the current data for each job of a functional unit in the current data table 1510. The user A 120A may view the projected end of year data for each job of a functional unit in the projected end-of-year table 1520. The data provided in the current data table 1510 and projected end-of-year table 1520 may be based on information provided by the user A 120A in FIGS. 6-10.

In the current data table 1510, the user A 120A may view the planned and current hiring data for each hire type of each job. For example, the user A 120A may view the planned full time hiring, part time hiring contingent hiring, contractor hiring, consultant hiring and outsourcing hiring for each job. The user A 120A may also view the year to date hiring for each job in the current data table 1510. The user A 120A may also view the headcount budgeted for each job for the year and the current variance between the actual hiring values and the budgeted headcount. In the projected end-of-year table 1520, the user A 120A may view the hiring values projected through the end of the year.

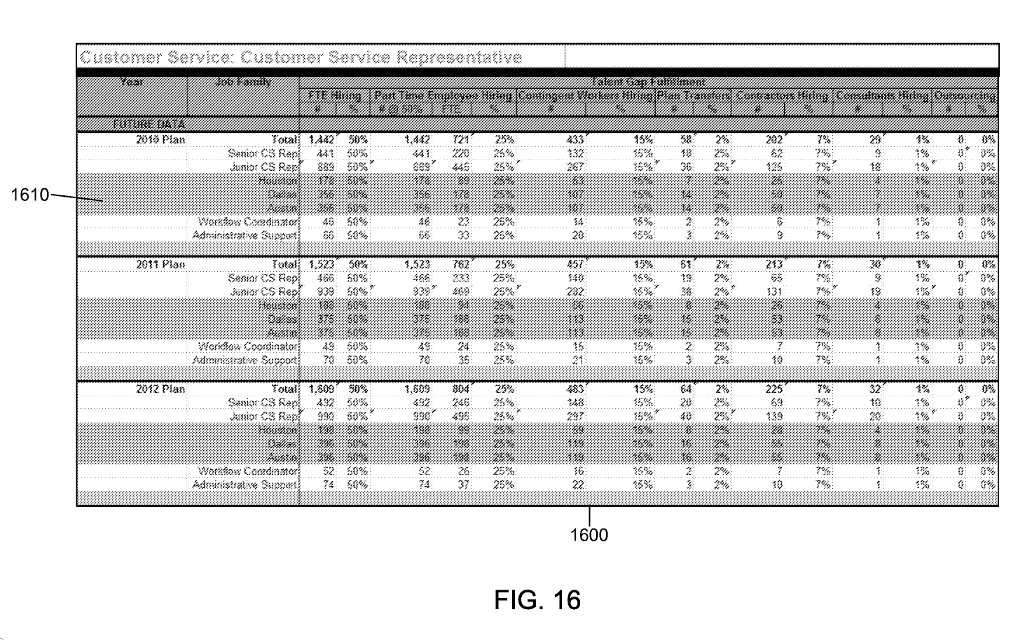

FIG. 16 is a screenshot of a user interface 1600 for viewing functional unit future data in the system of FIG. 1, or other systems for providing a workforce planning tool. The user interface 1600 may include a future data table 1610. In operation, the user A 120A may view the future data for a functional unit of the organization in the future data table 1610. For example, the service provider server 240 may process the data provided by the user A 120A in the user interfaces of FIGS. 6-10 to determine the future data for the functional unit of the organization displayed in the future data table 1310.

In the future data table 1610, the user A 120A may view the future hiring data for each hire type of each job over multiple periods of time. For example, the user A 120A may view the full time hiring, part time hiring contingent hiring, contractor hiring, consultant hiring and outsourcing hiring for each job over the next three years.

FIG. 17 is a screenshot of a user interface 1700 for viewing functional unit recruiting forecast data in the system of FIG. 1, or other systems for providing a workforce planning tool. The user interface 1700 may include a recruiting forecast table 1710. In operation, the user A 120A may use the recruiting forecast table 1710 to view data related to the recruiting forecast for a functional unit. For example, the service provider server 240 may process the data provided by the user A 120A in the user interfaces of FIGS. 6-10 to determine the recruiting forecast data for the functional unit of the organization displayed in the recruiting forecast data table 1710.

The recruiting forecast table 1710 may display the monthly forecasted recruiting data for each hire type for the current year. The monthly forecasted recruiting data may be categorized by each job of the functional unit. Alternatively or in addition, the monthly forecasted data for each job may be further categorized by each location of each job.

FIG. 18 is a screenshot of a user interface 1800 for viewing functional unit forecast variance data in the system of FIG. 1, or other systems for providing a workforce planning tool. The user interface 1800 may include a variance table 1810. In operation, the user A 120 may user the variance table 1810 to view data related to the variance in the recruiting forecast and the actual recruiting values. For example, the service provider server 240 may process the recruiting forecast provided by the user A 120A and the actual recruiting values to determine the variance values displayed in the variance table 1810.

The variance table 1810 may display the monthly variance values for each hire type for the current year. The monthly variance values may be categorized into each job of the functional unit. Alternatively or in addition, the monthly forecasted data for each job may be further categorized into each location of each job.

FIG. 19 is a screenshot of a user interface 1900 for viewing functional unit twelve month rolling updated plan data in the system of FIG. 1, or other systems for providing a workforce planning tool. The user interface 1900 may include a rolling plan table 1910. In operation, the user A 120 may view a twelve month rolling plan for a functional unit of the organization in the rolling plan table 1910. For example, the service provider server 240 may process the information provided by the user A 120A in FIGS. 6-10 to determine a rolling hiring plan for the functional unit. The service provider server 240 may transform the rolling hiring plan into the rolling plan table 1910 and may provide the user interface 1900 to the user A 120A.

The rolling plan table 1910 may display the twelve month rolling updated plan data for each hire type for the current year. The rolling plan data may be into each job of the functional unit. Alternatively or in addition, the rolling plan data for each job may be further categorized into each location of each job.

FIG. 20 is a screenshot of a user interface 2000 for viewing forecast accuracy data in the system of FIG. 1, or other systems for providing a workforce planning tool. The user interface 2000 may include a forecast accuracy table 2010. In operation, the user A 120A may view the accuracy of their recruiting forecast for each month of the previous year in the forecast accuracy table 2010. For example, the service provider server 240 may process the values provided by the user A 120A in FIGS. 6-10 to determine the accuracy of the recruiting forecast provided by the user A 120A. The accuracy values may be displayed for each hire type of the functional unit.

FIG. 21 is a screenshot of a user interface 2100 for viewing a business unit strategy report in the system of FIG. 1, or other systems for providing a workforce planning tool. The user interface 2100 may include a business unit selector 2102, a functional unit selector 2104, a year selector 2106, a section selector 2108, a total turnover table 2110, a workforce chum table 2120, a growth table 2220, a talent gap table 2230, a talent gap fulfillment hiring table 2150 and a budgeted headcount table 2160.

In operation, the user A 120A may view a hiring strategy for a business unit and/or a functional unit over a period of time. The user A 120A may identify one or more hiring trends based on the hiring strategy. For example, the user A 120A may select a business unit from the business unit selector 2102 and may select a functional unit from the functional unit selector 2104. The user A 120A may use the year selector 2106 to identify a period of time. If the user A 120A selects the current year as the period of time, the user A 120A may use the section selector 2108 to select a section of the current year, such as projected end of year.

The service provider server 240 may receive the values selected by the user A 120A and may provide the tables 2110, 2120, 2130, 2140, 2150, and 2160 based on the values selected by the user A 120A. The user A 120A may view the total turnover values in the total turnover table 2110. The user A 120A may view the workforce chum values in the workforce chum table 2120. The user A 120A may view the growth values in the growth table 2130. The user A 120A may view the talent gap values in the talent gap table 2140. The user A 120A may view the talent gap fulfillment values in the talent gap fulfillment table 2150. The user A 120A may view the budgeted headcount values in the budgeted headcount table 2160.

FIG. 22 is a screenshot of a user interface 2200 for viewing a business unit recruiting plan report in the system of FIG. 1, or other systems for providing a workforce planning tool. The user interface 2200 may include a functional unit selector 2202, a job family selector 2204, a region selector 2206, a month selector 2208, a metric selector 2209, a data return table 2210, an analysis section 2220, an implications table 2230, and a flag table 2240.

In operation, the user A 120A may view a recruitment strategy for a functional unit over a period of time. The user A 120A may select a functional unit from the functional unit selector 2102. The user A 120A may select a job family from the job family selector 2204. The user A 120A may select a region from the region selector 2206. The user A 120A may use the month selector 2108 to identify a period of time. The user A 120A may select a metric with the metric selector 2209.

The service provider server 240 may receive the values selected by the user A 120A and may provide the data return table 2210, the analysis section 2220, the implications table 2230, and the flag table 2240 based on the values selected by the user A 120A. The user A 120A may view data relating to the selected metric in the data return table 2210. The user A 120A may view an analysis of the recruiting strategy in the analysis table. The user A 120A may view the implications of the recruiting strategy in the implications table 2230. The user A 120A may view any flags associated with the data in the flags table 2240.

FIG. 23 is a screenshot of a user interface 2300 for viewing a business unit graphical report in the system of FIG. 1, or other systems for providing a workforce planning tool. The user interface 2300 may include a business unit/functional unit selector 2302, a function/job family selector 2304, a region selector 2306, a metric selector 2308, a graphical subsection 2310, and a talent gap table 2320. The graphical subsection 2310 may include a graphical representation 2315, and a key 2318.

In operation, the user A 120A may view a graphical representation of a business unit and/or functional unit in the graphical subsection 2310. The user A 120A may select a business unit or a functional unit using the business unit/functional unit selector 2302. The user A 120A may select a function or job family using the function/job family selector 2304. The user A 120A may select a region using the region selector 2306. The user A 120A may select a metric using the metric selector 2308.

The service provider server 240 may receive the values selected by the user A 120A and may provide the graphical subsection 2310 and the talent gap table 2320 based on the values selected by the user A 120A. The user A 120A may view the values of the selected metric over a period of time in the graphical representation 2315. If the user A 120A selected more than one function or job family, the key 2318 may display the line on the graphical representation 2315 associated with each function and job family. The user A 120A may view talent gap data for the selected business unit or functional unit in the talent gap table 2320.

FIG. 24 illustrates a general computer system 2400, which may represent a service provider server 240, or any of the other computing devices referenced herein. The computer system 2400 may include a set of instructions 2424 that may be executed to cause the computer system 2400 to perform any one or more of the methods or computer based functions disclosed herein. The computer system 2400 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 2400 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 2424 (sequential or otherwise) that specify actions to be taken by that machine. In a particular embodiment, the computer system 2400 may be implemented using electronic devices that provide voice, video or data communication. Further, while a single computer system 2400 may be illustrated, the term “system” shall also be taken to include any collection of systems or sub-systems that individually or jointly execute a set, or multiple sets, of instructions to perform one or more computer functions.

As illustrated in FIG. 24, the computer system 2400 may include a processor 2402, such as, a central processing unit (CPU), a graphics processing unit (GPU), or both. The processor 2402 may be a component in a variety of systems. For example, the processor 2402 may be part of a standard personal computer or a workstation. The processor 2402 may be one or more general processors, digital signal processors, application specific integrated circuits, field programmable gate arrays, servers, networks, digital circuits, analog circuits, combinations thereof, or other now known or later developed devices for analyzing and processing data. The processor 2402 may implement a software program, such as code generated manually (i.e., programmed).

The computer system 2400 may include a memory 2404 that can communicate via a bus 2408. The memory 2404 may be a main memory, a static memory, or a dynamic memory. The memory 2404 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 2404 may include a cache or random access memory for the processor 2402. Alternatively or in addition, the memory 2404 may be separate from the processor 2402, such as a cache memory of a processor, the system memory, or other memory. The memory 2404 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 2404 may be operable to store instructions 2424 executable by the processor 2402. The functions, acts or tasks illustrated in the figures or described herein may be performed by the programmed processor 2402 executing the instructions 2424 stored in the memory 2404. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 2400 may further include a display 2414, such as a liquid crystal display (LCD), an organic light emitting diode (OLED), a flat panel display, a solid state display, a cathode ray tube (CRT), a projector, a printer or other now known or later developed display device for outputting determined information. The display 2414 may act as an interface for the user to see the functioning of the processor 2402, or specifically as an interface with the software stored in the memory 2404 or in the drive unit 2406.

Additionally, the computer system 2400 may include an input device 2412 configured to allow a user to interact with any of the components of system 2400. The input device 2412 may be a number pad, a keyboard, or a cursor control device, such as a mouse, or a joystick, touch screen display, remote control or any other device operative to interact with the system 2400.

The computer system 2400 may also include a disk or optical drive unit 2406. The disk drive unit 2406 may include a computer-readable medium 2422 in which one or more sets of instructions 2424, e.g. software, can be embedded. Further, the instructions 2424 may perform one or more of the methods or logic as described herein. The instructions 2424 may reside completely, or at least partially, within the memory 2404 and/or within the processor 2402 during execution by the computer system 2400. The memory 2404 and the processor 2402 also may include computer-readable media as discussed above.

The present disclosure contemplates a computer-readable medium 2422 that includes instructions 2424 or receives and executes instructions 2424 responsive to a propagated signal; so that a device connected to a network 235 may communicate voice, video, audio, images or any other data over the network 235. Further, the instructions 2424 may be transmitted or received over the network 235 via a communication interface 2418. The communication interface 2418 may be a part of the processor 2402 or may be a separate component. The communication interface 2418 may be created in software or may be a physical connection in hardware. The communication interface 2418 may be configured to connect with a network 235, external media, the display 2414, or any other components in system 2400, or combinations thereof. The connection with the network 235 may be a physical connection, such as a wired Ethernet connection or may be established wirelessly as discussed below. Likewise, the additional connections with other components of the system 2400 may be physical connections or may be established wirelessly. In the case of a service provider server 240, the service provider server may communicate with users 120A-N through the communication interface 2418.

The network 235 may include wired networks, wireless networks, or combinations thereof. The wireless network may be a cellular telephone network, an 802.11, 802.16, 802.20, or WiMax network. Further, the network 235 may be a public network, such as the Internet, a private network, such as an intranet, or combinations thereof, and may utilize a variety of networking protocols now available or later developed including, but not limited to TCP/IP based networking protocols.

The computer-readable medium 2422 may be a single medium, or the computer-readable medium 2422 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 2422 may include a solid-state memory such as a memory card or other package that houses one or more non-volatile read-only memories. The computer-readable medium 2422 also may be a random access memory or other volatile re-writable memory. Additionally, the computer-readable medium 2422 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A computer-implemented method for providing a workforce planning tool, the method comprising:
receiving, by a processor from a device of a user, an organizational profile, an organizational growth profile, and an organizational hiring profile, wherein the organizational profile comprises a total number of a plurality of employees of an organization, the organizational growth profile comprises a growth percentage over a period of time and a net employee turnover over the period of time, and the organizational hiring profile comprises a hiring percentage over the period of time for each hire type of a plurality of hire types;
determining, by the processor, a talent gap comprising a total number of hires required by the organization over the period of time based on the total number of employees, the growth percentage and the net employee turnover;
determining, by the processor, a number of hires required over the period of time for each hire type of the plurality of hire types based on the hiring percentage for each hire type and the total number of hires;
transforming, by the processor, the number of hires required over the period of time for each hire type of the plurality of hire types into a hiring strategy, wherein the hiring strategy describes a strategy for fulfilling the total number of hires required over the period of time for each hire type; and
providing, by the processor to the device of the user, the hiring strategy.

2. The computer-implemented method of claim 1 wherein the organizational growth profile comprises a number of non-retirement terminations and a number of retirements.

3. The computer-implemented method of claim 2 wherein the net employee turnover for the period of time comprises the number of non-retirement terminations plus the number of retirements.

4. The computer-implemented method of claim 1 wherein determining, by the processor, the talent gap comprising the total number of hires required by the organization over the period of time based on the total number of employees, the growth percentage and the net employee turnover further comprises, determining, by the processor, the talent gap comprising the total number of hires required by the organization over the period of time by multiplying the growth percentage by the total number of employees and adding the net employee turnover.

5. The computer-implemented method of claim 1 wherein the period of time comprises at least one of a month or a year.

6. The computer-implemented method of claim 1 wherein determining, by the processor, the number of hires required over the period of time for each hire type of the plurality of hire types based on the hiring percentage for each hire type and the total number of hires further comprises determining, by the processor, the number of hires required over the period of time for each hire type of the plurality of hire types by multiplying the hiring percentage for each hire type by the number of hires required.

7. The computer-implemented method of claim 1 wherein the plurality of hire types comprises at least one of a full-time employee, a part time employee, a contingent employee, a contractor employee, or an outsourced employee.

8. The computer-implemented method of claim 1 further comprising:
receiving, by the processor from the device of the user, a budgeted total employees over the period of time;
determining, by the processor, a variance in the budgeted total employees based on the budgeted total employees and the total number of hires; and
providing, to the device of the user, the variance in the budgeted total employees over the period of time.

9. The computer-implemented method of claim 8 further comprising:
determining, by the processor, a total cost associated with the variance in the budgeted total employees; and
providing, by the processor to the device of the user, the total cost associated with the variance in the budgeted total employees.

10. The computer-implemented method of claim 1 wherein the hiring strategy comprises a graphical representation of the number of hires required over the period of time for each hire type of the plurality of hire types.

11. The computer-implemented method of claim 10 wherein the graphical representation of the hiring strategy is arranged based on a demographic of the plurality of employees of the organization.

12. The computer-implemented method of claim 11 wherein the demographic comprises at least one of an age demographic, a job level demographic, a job family demographic, or a geographic location demographic.

13. The computer-implemented method of claim 10 wherein the period of time comprises of a plurality of time intervals and the graphical representation of the hiring strategy is arranged based on the plurality of time intervals.

14. The computer-implemented method of claim 1 further comprising:
identifying, by the processor, a trend based on the hiring strategy; and
providing, to the device of the user, a description of the trend.

15. A computer-implemented method for providing a workforce planning tool for a plurality of jobs in an organization, the method comprising:
receiving, by a processor from a device of a user, an organizational profile, an organizational growth profile, and an organizational hiring profile, wherein the organizational profile comprises a total number employees for each job of a plurality of jobs in an organization, the organizational growth profile comprises a growth percentage for each job over a period of time and a net employee turnover for each job over the period of time, and the organizational hiring profile comprises a hiring percentage for each hire type of a plurality of hire types of each job over the period of time;
determining, by the processor, a talent gap comprising a total number of hires required for each job over the period of time based on the total number of employees for each job, the growth percentage for each job and the net employee turnover for each job;
determining, by the processor, a number of hires required over the period of time for each hire type of each job based on the hiring percentage for each hire type and the total number of hires for each job;
transforming, by the processor, the number of hires required over the period of time for each hire type of each job into a hiring strategy, wherein the hiring strategy describes a strategy for fulfilling the total number of hires required over the period of time for each hire type of each job; and
providing, by the processor to the device of the user, the hiring strategy.

16. The computer-implemented method of claim 15 wherein the organizational growth profile comprises a number of non-retirement terminations for each job, a number of retirements for each job, a number of employees transferred into each job, and a number of employees transferred out of each job.

17. The computer-implemented method of claim 16 wherein the net employee turnover for each job over the period of time comprises the number of employees transferred into each job subtracted from the number of employees transferred out of each job plus the number of non-retirement terminations plus the number of retirements.

18. The computer-implemented method of claim 16 wherein determining, by the processor, the talent gap comprising the total number of hires required for each job over the period of time based on the total number of employees for each job, the growth percentage for each job, and the net employee turnover for each job further comprises, determining, by the processor, the total number of hires required for each job over the period of time by multiplying the growth percentage by the total number of employees and adding the net employee turnover.

19. The computer-implemented method of claim 15 wherein the period of time comprises at least one of a month or a year.

20. The computer-implemented method of claim 15 wherein determining, by the processor, the number of hires required over the period of time for each hire type of each job based on the hiring percentage for each hire type of each job and the total number of hires for each job further comprises determining, by the processor, the number of hires required over the period of time for each hire type of each job by multiplying the hiring percentage for each hire type of each job by the number of hires required for each job.

21. The computer-implemented method of claim 15 wherein the plurality of hire types comprises at least one of a full-time employee, a part time employee, a contingent employee, a contractor employee, or an outsourced employee.

22. The computer-implemented method of claim 15 further comprising:
receiving, by the processor from the device of the user, a budgeted total employees for each job over the period of time;
determining, by the processor, a variance in the budgeted total employees for each job based on the budgeted total employees for each job and the total number of hires for each job; and
providing, to the device of the user, the variance in the budgeted total employees for each job over the period of time.

23. The computer-implemented method of claim 15 further comprising:
determining, by the processor, a total cost for each job associated with the variance in the budgeted total employees for each job; and
providing, by the processor to the device of the user, the total cost for each job associated with the variance in the budgeted total employees for each job.

24. The computer-implemented method of claim 15 wherein the hiring strategy comprises a graphical representation of the number of hires required over the period of time for each hire type of each job.

25. The computer-implemented method of claim 24 wherein the graphical representation of the hiring strategy is arranged based on a demographic of the plurality of employees of the organization.

26. The computer-implemented method of claim 24 wherein the period of time comprises of a plurality of time intervals and the graphical representation of the hiring strategy is arranged based on the plurality of time intervals.

27. The computer-implemented method of claim 15 further comprising:
identifying, by the processor, a trend based on the hiring strategy; and
providing, to the device of the user, a description of the trend.

28. A system for providing a workforce planning tool, the system comprising:
a memory to store an organizational profile, an organizational growth profile, and an organizational hiring profile, wherein the organizational profile comprises a total number of a plurality of employees of an organization, the organizational growth profile comprises a growth percentage over a period of time and a net employee turnover over the period of time, and the organizational hiring profile comprises a hiring percentage over the period of time for each hire type of a plurality of hire types;
an interface operatively connected to the memory, the interface operative to communicate with a device of a user; and
a processor operatively connected to the memory and the interface, the processor operative to receive, from the device of the user, the organizational profile, the organizational growth profile, and the organizational hiring profile, determine a total number of hires required by the organization over the period of time based on the total number of employees, the growth percentage and the net employee turnover, determine a talent gap comprising a number of hires required over the period of time for each hire type of the plurality of hire types based on the hiring percentage for each hire type and the total number of hires, transform the number of hires required over the period of time for each hire type of the plurality of hire types into a hiring strategy, wherein the hiring strategy describes a strategy for fulfilling the total number of hires required over the period of time for each hire type, and provide, to the device of the user, the hiring strategy.

29. The system of claim 28 wherein the organizational growth profile comprises a number of non-retirement terminations and a number of retirements.

30. The system of claim 29 wherein the net employee turnover for the period of time comprises the number of non-retirement terminations plus the number of retirements.

31. The system of claim 28 wherein the processor is further operative to determine the talent gap comprising the total number of hires required by the organization over the period of time by multiplying the growth percentage by the total number of employees and adding the net employee turnover.

32. The system of claim 28 wherein the period of time comprises at least one of a month or a year.

33. The system of claim 28 wherein the processor is further operative to determine the number of hires required over the period of time for each hire type of the plurality of hire types by multiplying the hiring percentage for each hire type by the number of hires required.

34. The system of claim 28 wherein the plurality of hire types comprises at least one of a full-time employee, a part time employee, a contingent employee, a contractor employee, or an outsourced employee.

35. The system of claim 28 wherein the processor is further operative to receive, from the device of the user, a budgeted total employees over the period of time, determine a variance in the budgeted total employees based on the budgeted total employees and the total number of hires, and provide, to the device of the user, the variance in the budgeted total employees over the period of time.

36. The system of claim 35 wherein the processor is further operative to determine a total cost associated with the variance in the budgeted total employees, and provide, to the device of the user, the total cost associated with the variance in the budgeted total employees.

37. The system of claim 28 wherein the hiring strategy comprises a graphical representation of the number of hires required over the period of time for each hire type of the plurality of hire types.

38. The system of claim 37 wherein the graphical representation of the hiring strategy is arranged based on a demographic of the plurality of employees of the organization.

39. The system of claim 38 wherein the demographic comprises at least one of an age demographic, a job level demographic, a job family demographic, or a geographic location demographic.

39. The system of claim 37 wherein the period of time comprises of a plurality of time intervals and the graphical representation of the hiring strategy is arranged based on the plurality of time intervals.

40. The system of claim 28 wherein the processor is further operative to identify a trend based on the hiring strategy and provide, to the device of the user, a description of the trend.
